(19) United States
(12) Patent Application Publication
(10) Pub. No.: US 2015/0047017 A1
(43) Pub. Date: Feb. 12, 2015

(54) MOBILE DEVICE AND METHOD OF CONTROLLING THEREFOR

(71) Applicant: LG ELECTRONICS INC., Seoul (KR)

(72) Inventors: Yongsin KIM, Seoul (KR); Doyoung LEE, Seoul (KR); Hyorim PARK, Seoul (KR)

(73) Assignee: LG ELECTRONICS INC., Seoul (KR)

(21) Appl. No.: 14/021,664

(22) Filed: Sep. 9, 2013

(30) Foreign Application Priority Data
Aug. 9, 2013 (KR) 10-2013-0094933

(51) Int. Cl. G06F 21/36

(52) U.S. Cl. CPC G06F 21/36
USPC 726/19

(57) ABSTRACT

The present specification relates to a mobile device and a method of controlling therefor, and more particularly, to a mobile device providing a user interface of a different security level according to a fingerprint verification and a touch input trajectory and a method of controlling therefor.

This application claims the benefit of the Korean Patent Application No. 10-2013-0094933, filed on Aug. 9, 2013, which is hereby incorporated by reference as if fully set forth herein.

### BACKGROUND OF THE INVENTION

1. Field of the Invention

The present specification relates to a mobile device and a method of controlling therefor, and more particularly, to a mobile device providing a user interface of a different security level according to a fingerprint verification and a touch input trajectory and a method of controlling therefor.

2. Discussion of the Related Art

A fingerprint means a pattern made by a curve of a last knuckle of a finger. And, when the last knuckle of a finger pushes an object, a curve pattern is left on a surface of the object. In this case, the curve pattern can be defined as a fingerprint. Since a fingerprint does not change for good and everyone has a unique shape of fingerprint of its own, a security technology using a fingerprint has been developed.

As a representative example of the security technology using the fingerprint, there is a fingerprint verification technology. Fingerprint verification is one of a biometrics and corresponds to an authentication scheme performed by informationizing fingerprint information different across individuals in a manner of extracting the fingerprint information. Hence, as a method of unlocking a smart phone and the like, which requires a protection of private information, a use of the fingerprint verification technology is under discussion.

Meanwhile, most of mobile devices including a smart phone can detect a touch input of a user for a display unit. Yet, since a touch input cannot distinguish a user from a different user, it is hard to provide a user interface in a manner of classifying a security level according to the touch input.

### SUMMARY OF THE INVENTION

Accordingly, the present specification is directed to an apparatus and method thereof that substantially obviate one or more problems due to limitations and disadvantages of the related art.

One embodiment of the present specification intends to check a user via fingerprint verification and to provide a user interface of a different security level according to a length of a touch trajectory.

Another embodiment of the present specification intends to check a user via fingerprint verification and to provide a different type of user interface according to a direction of a touch trajectory.

Another embodiment of the present specification intends to provide a user interface of a different security level according to fingerprint verification and a length of a touch trajectory irrespective of a sequence of the fingerprint verification and touch recognition.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, according to one embodiment, a mobile device can include a sensor unit, a display unit, and a processor configured to control the sensor unit and the display unit. In this case, the processor is configured to detect a first touch input on a fingerprint verification area, extract a fingerprint information using the first touch input on the fingerprint verification area, detect a second touch input concatenated to the first touch input within a preset time period from a point on which the first touch input is detected when the extracted fingerprint information is matched with a pre-stored fingerprint information, recognize a touch trajectory made by the second touch input, and provide a user interface corresponding to a security level preset according to a length of the touch trajectory.

According to one embodiment, a method of controlling a mobile device includes the steps of detecting a first touch input on a fingerprint verification area, extracting a fingerprint information using the first touch input on the fingerprint verification area, detecting a second touch input concatenated to the first touch input within a preset time period from a point on which the first touch input is detected when the extracted fingerprint information is matched with a pre-stored fingerprint information, recognizing a touch trajectory made by the second touch input, and providing a user interface corresponding to a security level preset according to a length of the touch trajectory.

According to one embodiment, a mobile device can include a sensor unit, a display unit, and a processor configured to control the sensor unit and the display unit. In this case, the processor is configured to detect a first touch input on a display area, recognize a touch trajectory made by the first touch input, detect a second touch input concatenated to the first touch input on a fingerprint verification area within a preset time period from a point on which the first touch input is detected, extract a fingerprint information using the second touch input on the fingerprint verification area, and provide a user interface corresponding to a security level preset according to a length of the touch trajectory when the fingerprint information is matched with a pre-stored fingerprint information.

According to one embodiment, a method of controlling a mobile device can include the steps of detecting a first touch input on a display area, recognizing a touch trajectory made by the first touch input, detecting a second touch input concatenated to the first touch input on a fingerprint verification area within a preset time period from a point on which the first touch input is detected, extracting a fingerprint information using the second touch input on the fingerprint verification area, and providing a user interface corresponding to a security level preset according to a length of the touch trajectory when the fingerprint information is matched with a pre-stored fingerprint information.

According to one embodiment, a security can be strengthened in a manner of checking a user via fingerprint verification and providing a user interface of a different security level according to a length of a touch trajectory.

According to another embodiment, a convenience of a user can be enhanced in a manner of checking a user via fingerprint verification and providing a different type of user interface according to a direction of a touch trajectory.

According to another embodiment, a range of selection of a user can be widened in a manner of providing a user interface of a different security level according to fingerprint verification and a length of a touch trajectory irrespective of a sequence of the fingerprint verification and touch recognition.

It is to be understood that both the foregoing general description and the following detailed description of the present specification are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a functional block diagram of a mobile device according to one embodiment;

FIG. 2 is a diagram for one embodiment of a display area and a fingerprint verification area of a mobile device;

FIG. 3 is a diagram for one embodiment that a mobile device detects a length of a touch trajectory;

FIG. 4 is a diagram for one embodiment that a mobile device provides a user interface of a different security level according to a length of a touch trajectory;

FIG. 5 is a diagram for a different embodiment that a mobile device provides a user interface of a different security level according to a length of a touch trajectory;

FIG. 6 is a diagram for one embodiment that a mobile device provides a user interface of a different security level for a specific application;

FIG. 7 is a diagram for a different embodiment that a mobile device provides a user interface of a different security level for a specific application;

FIG. 8 is a diagram for one embodiment that a mobile device detects a direction and a length of a touch trajectory;

FIG. 9 is a diagram for one embodiment that a mobile device detects a length of a touch trajectory and a fingerprint;

FIG. 10 is a flowchart for a method of controlling a mobile device according to one embodiment;

FIG. 11 is a flowchart for a method of controlling a mobile device according to a different embodiment.

### DETAILED DESCRIPTION OF THE INVENTION

In the following detailed description, reference is made to the accompanying drawing figures which form a part hereof, and which show by way of illustration specific embodiments of the invention. It is to be understood by those of ordinary skill in this technological field that other embodiments may be utilized, and structural, electrical, as well as procedural changes may be made without departing from the scope of the present specification. Wherever possible, the same reference numbers will be used throughout the drawings to refer to the same or similar parts.

Although terminologies used in the present specification are selected from general terminologies used currently and widely in consideration of functions, they may be changed in accordance with intentions of technicians engaged in the corresponding fields, customs, advents of new technologies and the like. Occasionally, some terminologies may be arbitrarily selected by the applicant(s). In this case, the meanings of the arbitrarily selected terminologies shall be described in the corresponding part of the detailed description of the specification. Therefore, terminologies used in the present specification need to be construed based on the substantial meanings of the corresponding terminologies and the overall matters disclosed in the present specification rather than construed as simple names of the terminologies.

Moreover, while the embodiments have been concretely described with reference to the attached diagrams and the contents written on the diagrams, the present specification may be non-restricted or non-limited to the embodiments.

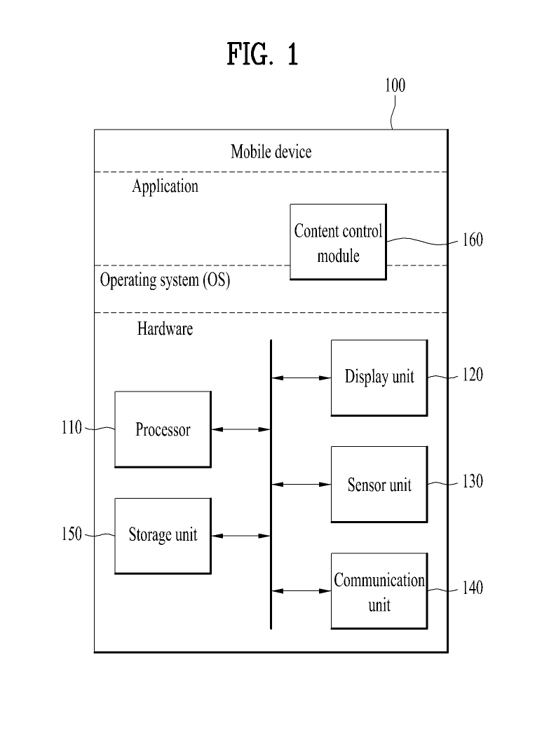

FIG. 1 is a functional block diagram of a mobile device according to one embodiment. Yet, FIG. 1 is just one embodiment and a part of configuring module can be deleted or a new configuring module can be added according to the necessity of those skilled in the art.

As depicted in FIG. 1, a mobile device 100 according to one embodiment can include a hardware layer, an operating system layer, and an application layer.

First of all, the hardware layer of the mobile device 100 can include a processor 110, a display unit 120, a sensor unit 130, a communication unit 140, and a storage unit 150.

First of all, the display unit 120 can output an image in a display screen. The display unit 120 can output an image based on content executed by the processor 110 or a control command of the processor 110. According to one embodiment, the display unit 120 can display a user interface to output content, an image, or the like.

The sensor unit 130 is configured to sense a neighbor environment of the mobile device 100 using at least one sensor installed in the mobile device 100 and can deliver the neighbor environment to the processor 110 in a form of a signal. And, the sensor unit 130 is configured to sense a user input and can deliver a signal according to a sensed result to the processor 110. In this case, the processor 110 can detect the signal generated by the user input together with the signal delivered from the touch sensor among a plurality of received signals.

Hence, the sensor unit 130 can include at least one sensing means. As one embodiment, the at least one sensing means can include such a sensing means as a gravity sensor, a terrestrial magnetism sensor, a motion sensor, a gyroscope sensor, an acceleration sensor, an infrared sensor, a tilt (inclination) sensor, a brightness sensor, an altitude sensor, a smell sensor, a temperature sensor, a depth sensor, a pressure sensor, a bending sensor, an audio sensor, a video sensor, a GPS (global positioning system) sensor, a touch sensor, a grip sensor, and the like.

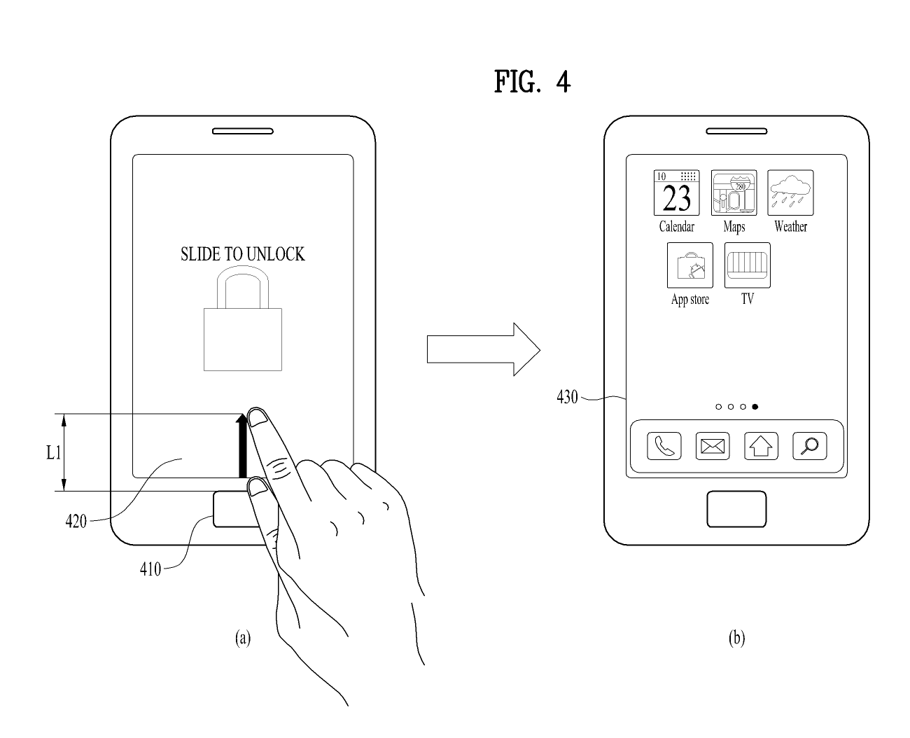

And, the sensor unit 130 can detect an input signal for the mobile device 100. In this case, the input signal for the mobile device 100 can include a gaze input, a touch input, a voice input, a gesture input, and the like for the mobile device 100. This shall be described in detail with reference to FIG. 4.

And, the sensing unit 130 is a common name of the aforementioned various sensing means and can deliver sensed results to the processor to enable the processor 110 to perform an operation according to the sensed results in a manner of sensing various inputs of a user and an environment of the mobile device 100. The aforementioned sensors may be included in the mobile device 100 as a separate element or may be included in the mobile device in a manner of being combined by an at least one element.

According to one embodiment, the mobile device 100 can install the sensor unit 130 on the display unit 120 together. By doing so, the mobile device 100 can detect various user inputs performed on the display unit 120 via the sensor unit 130.

For instance, in case that the sensor unit 130 includes a touch sensor, the mobile device 100 can receive various touch inputs of a user performed on the display unit 120. And, in case that the sensor unit 130 includes a fingerprint sensor, the mobile device 100 can collect fingerprint information of a corresponding user from a user input performed on the display unit 120. As mentioned in the foregoing description, the mobile device 100 according to one embodiment can be equipped with a screen sensor forming a mutual layer structure, which is formed by the display unit 120 and the sensor unit 130.

Meanwhile, the mobile device 100 according to a different embodiment can be equipped with a touch sensor and a fingerprint sensor together. The touch sensor and the fingerprint sensor can form a mutual layer structure and the mobile device can collect fingerprint information of a corresponding user from a user input performed on the touch sensor. In this case, the touch sensor and the fingerprint sensor can form a layer together with the display unit 120. Or, the touch sensor and the fingerprint sensor can form a layer separately configured from the display unit 120. For instance, the fingerprint sensor can be installed in a hardware button separately mounted on the mobile device 100 such as a home button

And, the processor 110 can detect a signal delivered from at least one of the display unit 120 and the sensor unit 130 among a plurality of signals delivered from a configuration unit. In particular, the processor 110 can detect a signal generated by a user input, which is received from a specific sensor, among a plurality of the received signals. For instance, if the sensor unit 130 senses a user input, the processor 110 can detect a signal corresponding to the input using the sensed result.

In the following description, if each step or operation performed by the mobile device is initiated or progressed by a user input, assume that a process of generating a signal includes explanation on the aforementioned process, even though it is not duplicately explained.

And, it can be represented that the processor controls the mobile device or the configuration unit included in the mobile device according to a user input. And, the processor and the mobile device can be explained as a same meaning.

The communication unit 140 can transceive a data with an external device in a manner of performing a communication with the external device using various protocols. The communication unit accesses an external network in wired or wireless and can transceive such a digital data as content, an application, and the like with the external network.

The storage unit 150 can store such various digital data as an audio, a picture, a video, an application, and the like. The storage unit indicates such various digital storage spaces as a flash memory, a RAM (random access memory), a SSD (solid state drive), and the like.

The mobile device 100 according to one embodiment can store an application, information related to a user interface corresponding to a home screen, and a security level according to a type of the user interface. And, the mobile device 100 can store a security level according to content. Hence, the mobile device can store a security level of the user interface to provide the content as well.

And, the processor 110 can execute the content stored in the storage unit 150, the content received via a data communication, or the like. And, the processor 110 executes various applications and can provide a user interface corresponding to the applications.

And, the processor 110 drives a content control module 160 and can control the content of the mobile device 100 based on a control command of the content control module 160. Moreover, the processor 110 controls each of the aforementioned units of the mobile device 100 and can control a data transmission and reception between the units.

An operating system layer of the mobile device 100 can include an operating system to control each of the units. The operating system makes an application of the mobile device 100 control each unit of hardware layer and use each unit of the hardware layer. The operating system prepares an environment capable of performing each application in a manner of efficiently distributing a resource of the mobile device 100.

Meanwhile, an application layer of the mobile device 100 can include at least one application. An application can include a program of various forms and a user interface enabling a specific work to be performed. An application can use a resource of the hardware layer with the help of the operating system.

According to one embodiment, the mobile device 100 can be equipped with a content control module 160 to control content. According to one embodiment, the content control module 160 controls a conversion between a plurality of display pages included in the content of the mobile device 100 and can control a user interface for providing the content. In particular, the content control module 160 may become an embedded software installed in the operating system of the mobile device 100 or may become a software included in the application layer.

And, the mobile device 100 depicted in FIG. 1 is a block diagram according to one embodiment. Blocks represented in a manner of being separated indicate the logically distinguished elements of the device. Hence, the elements of the aforementioned device can be equipped with a single chip or a plurality of chips according to the design of the device.

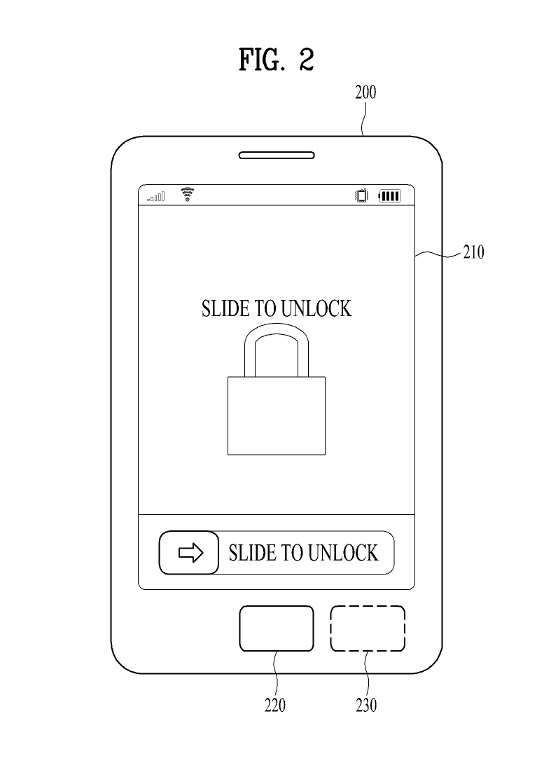

FIG. 2 is a diagram for one embodiment of a display area and a fingerprint verification area of a mobile device.

The mobile device according to one embodiment can include a display area 210 and a fingerprint verification area 230. The mobile device can display a user interface corresponding to content or an application in the display area 210. And, as depicted in FIG. 2, the mobile device 200 displays a locked state in the display area 210 and can provide a user interface to unlock the locked state in the display area 210.

And, the mobile device 200 detects a touch input of a user on the fingerprint verification area 230 and can extract fingerprint information using the touch input. In this case, the touch input of the user may include a sliding input and the mobile device can extract fingerprint information from the sliding input.

And, if the extracted fingerprint information of the user is matched with pre-stored fingerprint information, the mobile device 200 can unlock the locked state of the mobile device 200 without any additional operation. And, since the locked state of the mobile device is unlocked, the mobile device 200 sets the touch screen, i.e., the display area 210 to an enabled state and can provide private information of the user. Since fingerprint information is different across individuals, if the fingerprint information is used, a security can be strengthened and a user interface according to a user can be provided.

And, as depicted in FIG. 2, the fingerprint verification area 230 can be situated at a body of the mobile device 200. Or, as mentioned earlier in FIG. 1, the fingerprint verification area 230 may be identical to the display area 210 or may be identical to a home button area 220. In particular, if a fingerprint sensor is installed in such a hardware button as a home button, the home button area 220 can be identical to the fingerprint verification area 230.

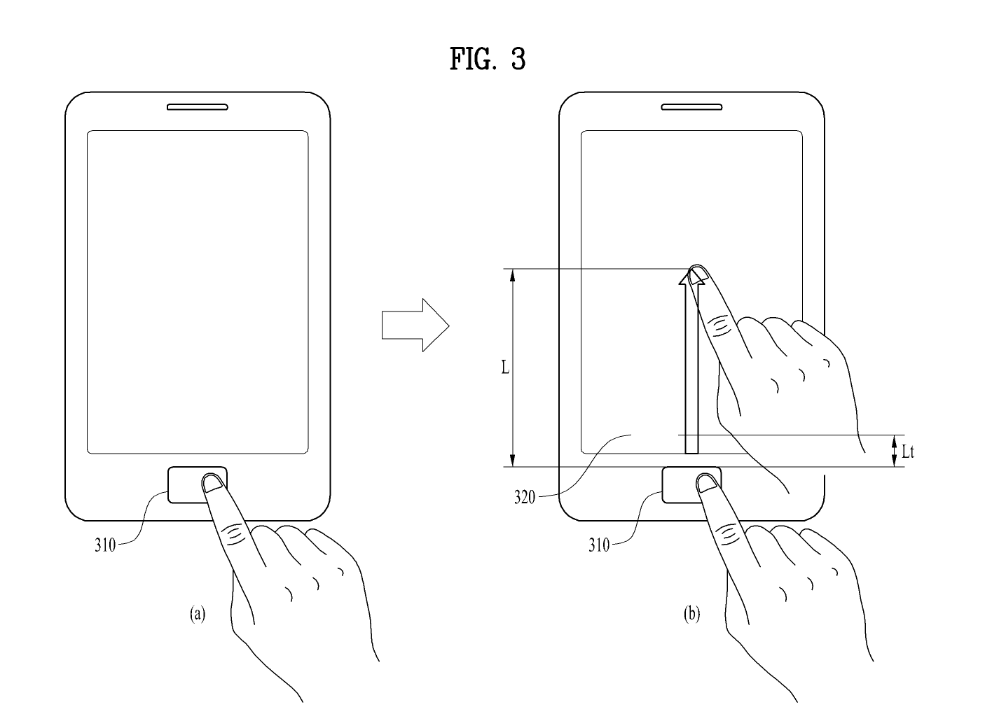

FIG. 3 is a diagram for one embodiment that a mobile device detects a length of a touch trajectory.

As depicted in FIG. 3 (a), the mobile device according to one embodiment can detect a first touch input on the fingerprint verification area 310. In this case, the mobile device extracts fingerprint information using the first touch input. If the extracted fingerprint information is matched with pre-stored fingerprint information, the mobile device can detect a second touch input.

The second touch input is a touch input concatenated to the first touch input and should be a touch input detected within a preset time period from a point on which the mobile device has detected the first touch input. Hence, as depicted in FIG. 3 (b), if the mobile device detects the first touch input on the fingerprint verification area 310, the mobile device can detect the second touch input on the display area 320 within the preset time period from the point on which the first touch input is detected.

In this case, the second touch input may correspond to a drag input. And, since the second touch input is concatenated to the first touch input, a user starts a touch input on the fingerprint verification area 310 and can drag the touch input to the display area 320. Then, the mobile device can recognize the touch input on the fingerprint verification area 310 as the first touch input and the touch input on the display area 320 as the second touch input for the concatenated touch input of the user.

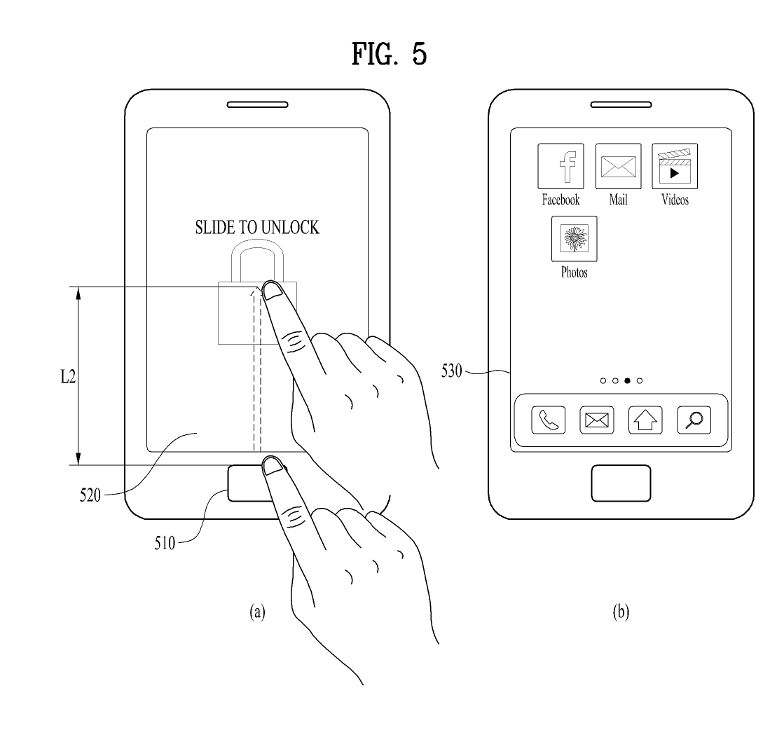

And, the mobile device can recognize a touch trajectory made by the second touch input. This is because the mobile device intends to provide a user interface corresponding to a security level, which is preset according to a length of the touch trajectory. For instance, as the length of the touch trajectory increases, the mobile device can provide a user interface of a higher security level, which is preset. This shall be explained in detail with reference to FIG. 4 to FIG. 5.

Yet, as depicted in FIG. 3 (b), if the length of the touch trajectory made by the second touch input is shorter than a preset reference length (Lt), the mobile device can ignore the second touch input. This is because there may exist a case of touching the display area 320 by slipping a hand of a user after the fingerprint verification area 310 is touched or a case of an incorrect operation.

FIG. 4 is a diagram for one embodiment that a mobile device provides a user interface of a different security level according to a length of a touch trajectory.

As depicted in FIG. 4 (a), the mobile device can detect a first touch input on the fingerprint verification area 410. The mobile device extracts fingerprint information using the first touch input on the fingerprint verification area 410 and can judge whether the fingerprint information is matched with pre-stored fingerprint information. If the fingerprint information is matched with the pre-stored fingerprint information, the mobile device unlocks a locked state of the mobile device and can provide a user interface corresponding to a home screen.

Yet, if a second touch input concatenated to the first touch input is detected within a preset time period from a point on which the first touch input is detected, the mobile device extracts a length (L1) of a touch trajectory made by the second touch input and can provide a preset user interface corresponding to a security level according to the length (L1) of the touch trajectory.

Hence, the mobile device according to one embodiment can detect whether the second touch input exists for the preset time period without immediately providing the user interface corresponding to the home screen although the locked state is unlocked by the first touch input.

Hence, if there does not exist the second touch input concatenated to the first touch input within the preset time period from the point on which the first touch input is detected, the mobile device can provide a user interface corresponding to a normal home screen. On the contrary, if the second touch input concatenated to the first touch input is detected within the preset time period from the point on which the first touch input is detected, the mobile device can recognize a touch trajectory made by the second touch input.

In this case, the mobile device can store a security level of a user interface according to a length of a touch trajectory in advance. By doing so, as depicted in FIG. 4 (b), the mobile device can provide a user interface 430 corresponding to a security level, which is set in advance according to the length (L1) of the touch trajectory of the second touch input.

For instance, as the length of the touch trajectory increases, the mobile device can provide a preset user interface of a higher security level. Yet, referring to FIG. 4 (a), since the length (L1) of the detected touch trajectory is shorter than a preset reference, assume that a preset user interface 430 of a lower security level is configured. By doing so, the mobile device can provide the user interface 430 including such applications containing less private information of a user as a ‘Calendar’, a ‘Map’, ‘Weather’, an ‘App store’, a ‘TV’, and the like.

FIG. 5 is a diagram for a different embodiment that a mobile device provides a user interface of a different security level according to a length of a touch trajectory. Although it is similar to the aforementioned one embodiment of FIG. 4, one embodiment of FIG. 5 describes a case that a length (L2) of a touch trajectory according to FIG. 5 is longer than the length (L1) of the touch trajectory according to FIG. 4.

As depicted in FIG. 5 (a), the mobile device can detect a first touch input on the fingerprint verification area 510. The mobile device extracts fingerprint information using the first touch input on the fingerprint verification area 510 and can judge whether the fingerprint information is matched with pre-stored fingerprint information. If the fingerprint information is matched with the pre-stored fingerprint information, the mobile device unlocks a locked state of the mobile device and can provide a user interface corresponding to a home screen.

Yet, if a second touch input concatenated to the first touch input is detected within a preset time period from a point on which the first touch input is detected, the mobile device extracts a length (L2) of a touch trajectory made by the second touch input and can provide a preset user interface corresponding to a security level according to the length (L2) of the touch trajectory.

Hence, the mobile device according to one embodiment can detect whether the second touch input exists for the preset time period without immediately providing the user interface corresponding to the home screen although the locked state is unlocked by the first touch input.

Hence, if there does not exist the second touch input concatenated to the first touch input within the preset time period from the point on which the first touch input is detected, the mobile device can provide a user interface corresponding to a normal home screen. On the contrary, if the second touch input concatenated to the first touch input is detected within the preset time period from the point on which the first touch input is detected, the mobile device can recognize a touch trajectory made by the second touch input.

As mentioned in the foregoing description, the mobile device can store a security level of a user interface according to a length of a touch trajectory in advance. By doing so, as depicted in FIG. 5 (b), the mobile device can provide a user interface 530 corresponding to a security level, which is set in advance according to the length (L2) of the touch trajectory of the second touch input.

The length (L2) of the touch trajectory according to FIG. 5 (a) is longer than the length of the touch trajectory according to FIG. 4 (a). Hence, the mobile device according to FIG. 5 can provide a user interface of a security level, which is higher than the security level of the user interface of the mobile device according to FIG. 5. Hence, the mobile device can provide the user interface 530 including such applications containing private information of a user as ‘Facebook’, a ‘Mail’, a ‘Videos’, a ‘Photos’, and the like.

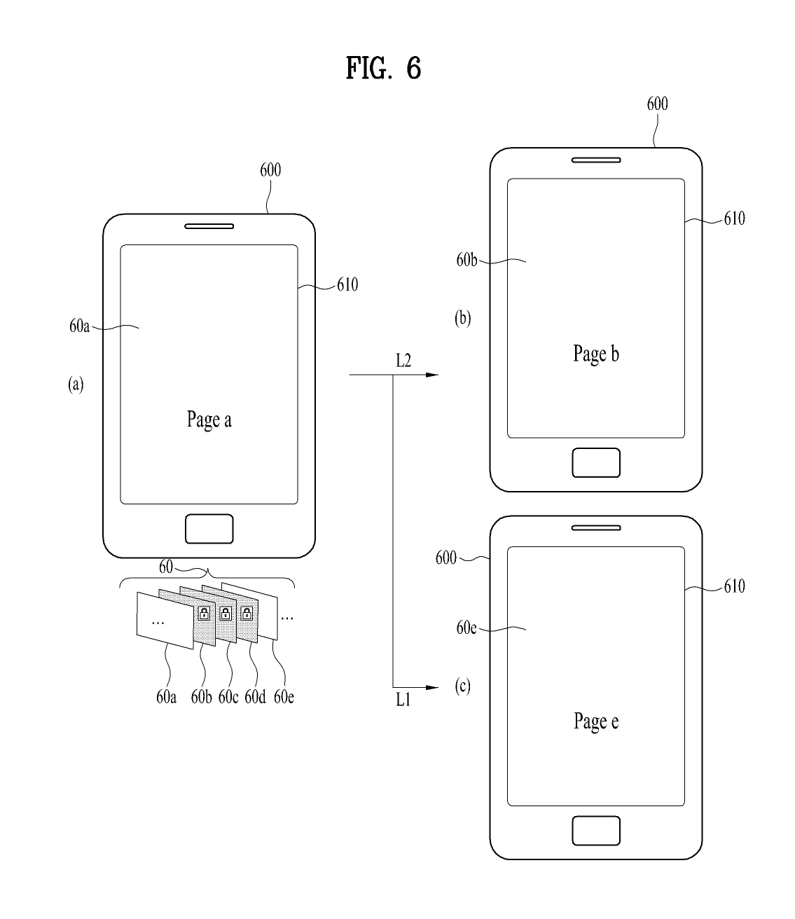

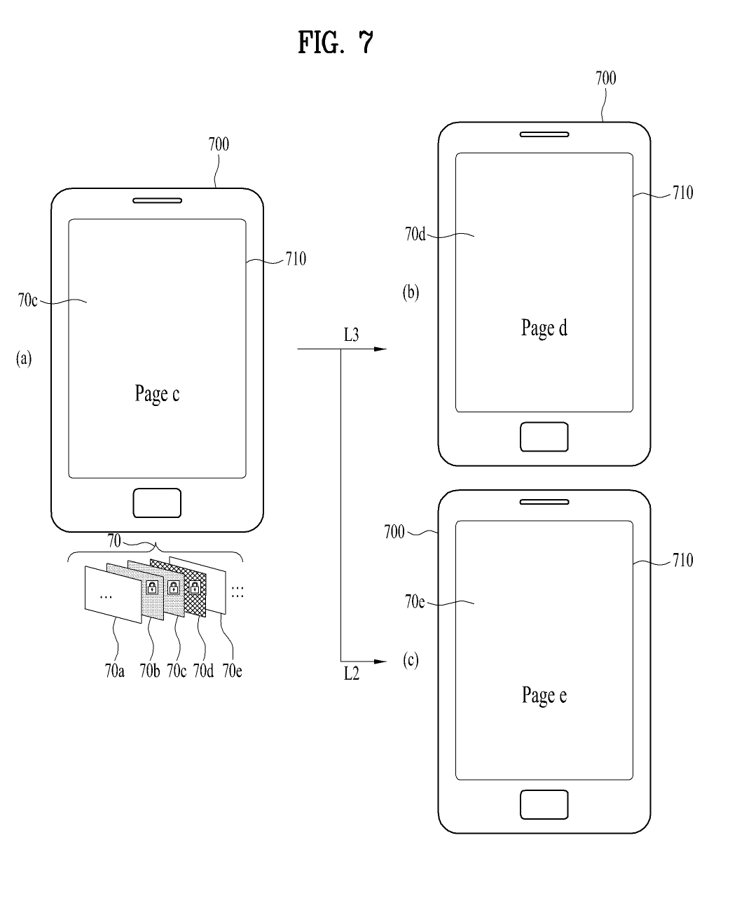

Meanwhile, in FIG. 4 to FIG. 5, one embodiment that the mobile device in a locked state automatically unlocks the locked state by a fingerprint verification of a user and a user interface of a different security level is provided according to a length of a touch trajectory is described. In particular, providing a user interface of a different security level provided by a mobile device in a home screen is described as one embodiment in FIG. 4 to FIG. 5. Yet, the user interface can include at least one selected from the group consisting of a shortcut, content, and an application besides the aforementioned embodiment. In the following description, one embodiment that a mobile device provides a user interface of a different security level for a specific application according to a length of a touch trajectory is explained with reference to FIG. 6 to FIG. 7.

FIG. 6 is a diagram for one embodiment that a mobile device provides a user interface of a different security level for a specific application. A specific application according to FIG. 6 is an application for displaying content. The content may correspond to pictures or may include a digital document and the like.

In FIG. 6, contents 60 may include a plurality of display pages forming a sequence of a 60a, a 60b, a 60c, a 60d, and a 60e. In this case, a display page 60a and a display page 60e are contents to which a security level is set to low and a display page 60b, 60c, and 60d are contents to which the security level is set to high. In particular, in FIG. 6, a plurality of concatenated display pages 60b, 60c, 60d can be displayed only when a user interface of higher security level is provided due to a long touch trajectory.

Referring to FIG. 6 (a), the mobile device 600 can detect a first touch input on the fingerprint area and a second touch input on the display area in a state that the mobile device displays the display page 60a in a display screen. In this case, unlike the above mentioned, the second touch input may correspond to a touch input not concatenated to the first touch input. Yet, although the second touch input is not concatenated to the first touch input, it is identical that the mobile device 600 should detect the second touch input within a preset time period from a point on which the first touch input is detected.

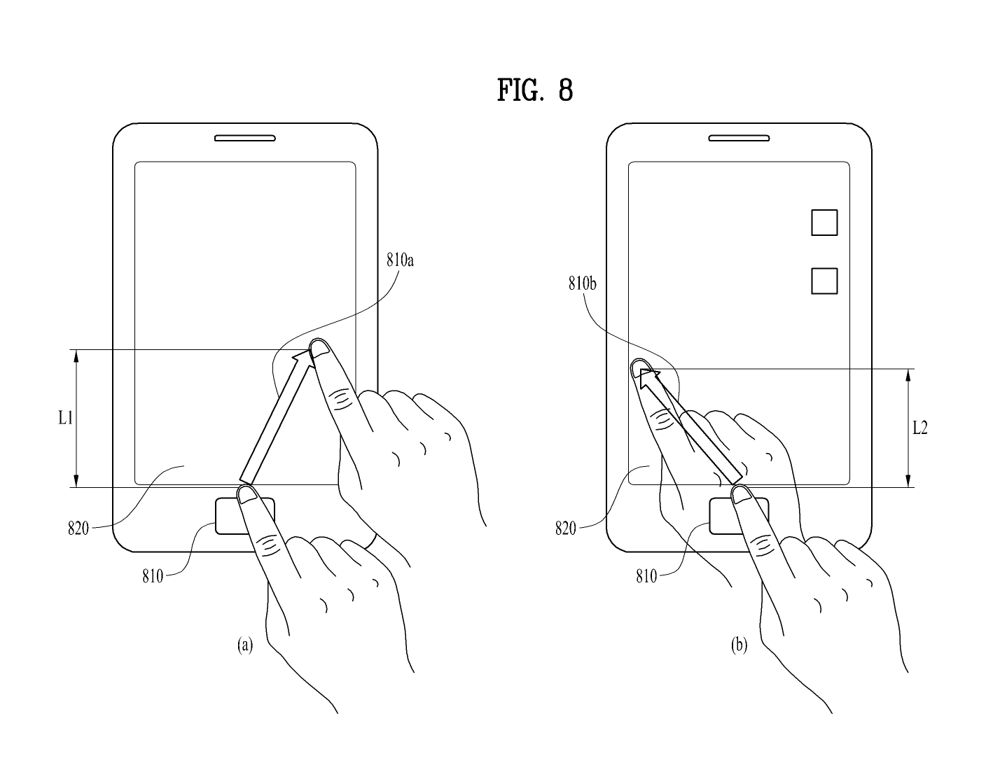

And, the second touch input can include a user input dragging to the right. In particular, the mobile device 600 recognizes a touch direction made by the second touch input and can provide a different type of user interface according to the touch direction. This shall be described in detail with reference to FIG. 8.

And, the mobile device recognizes a touch trajectory of the second touch input and can extract a length of the touch trajectory. In this case, the mobile device can provide a user interface of a different security level according to the length of the extracted touch trajectory.

For instance, the length of the touch trajectory extracted by the mobile device 600 may correspond to L1 or L2 (in this case, assume that the L1 is shorter than the L2). The mobile device 600 determines a security level according to the length of the touch trajectory and can provide a permissible user interface according to the security level.

First of all, in case that the length of the touch trajectory extracted by the mobile device 600 corresponds to the L1, since the L1 is shorter than a preset reference in length, the mobile device 600 can provide a user interface of a low security level. By doing so, as depicted in FIG. 6 (c), the mobile device 600 skips a conversion to the display pages 60b, 60c, 60d set with a high security level and can display a user interface corresponding to the display page 60e in a screen 610.

Subsequently, in case that the length of the touch trajectory extracted by the mobile device 600 corresponds to the L2, since the L2 is longer than the preset reference in length, the mobile device 600 can provide a user interface of a high security level. By doing so, as depicted in FIG. 6 (b), the mobile device 600 can display a user interface corresponding to the display page 60b set with a high security level in the screen 610.

As mentioned in the foregoing description, although an identical user uses the mobile device, the mobile device 600 can change a user interface provided according to the length of the touch trajectory. In particular, if the length (L2) of the touch trajectory is long, the mobile device 600 can switch the contents provided in the screen 610 in a sequence of 60a, 60b, 60c, 60d, and 60e. Yet, if the length (L1) of the touch trajectory is short, the mobile device skips the display page 60b to 60d and can provide a user interface corresponding to the display page 60e in the screen 610.

In this case, the display page 60e is situated at the right (i.e., page shift direction) of the display page 60b in the sequence. Hence, if the direction of the second touch input corresponds to the left, the mobile device can provide a display page set as a previous page of the display page 60a in a sequence on the basis of the display page 60a. Regarding the direction of the second touch input, it is explained in detail with reference to FIG. 8.

FIG. 7 is a diagram for a different embodiment that a mobile device provides a user interface of a different security level for a specific application. In FIG. 7, contents 70 may include a plurality of display pages forming a sequence of a 70a, a 70b, a 70c, a 70d, and a 70e. In this case, a display page 70a and a display page 70e are contents to which a security level is set to a first stage, which is lowest security level, a display page 70b and 70c are contents to which the security level is set to a second stage, which is a medium security level, and the display page 70d is content to which the security level is set to a third level, which is a highest security level. Hence, as the length of the touch trajectory is longer, the mobile device can display a user interface of a higher security level.

Referring to FIG. 7 (a), the mobile device 700 can detect a first touch input on the fingerprint area and a second touch input on the display area in a state that the mobile device displays the display page 70c in a display screen 710. In this case, the second touch input may correspond to a touch input concatenated or not concatenated to the first touch input. Regarding this, since it is identical to the above mentioned, detailed explanation is omitted.

And, the second touch input can include a user input dragging to the right. In particular, the mobile device 600 recognizes a touch direction made by the second touch input and can provide a different type of user interface according to the touch direction. This shall be described in detail with reference to FIG. 8.

And, the mobile device recognizes a touch trajectory of the second touch input and can extract a length of the touch trajectory. In this case, the mobile device can provide a user interface of a different security level according to the length of the extracted touch trajectory.

For instance, the length of the touch trajectory extracted by the mobile device 700 may correspond to L2 or L2 (in this case, assume that the L2 is shorter than the L3). The mobile device 700 determines a security level according to the length of the touch trajectory and can provide a permissible user interface according to the security level. In this case, assume that a user interface of the first stage security level is set if the length of the touch trajectory corresponds to the L2 and assume that a user interface of the third stage security level is set if the length of the touch trajectory corresponds to the L3.

Hence, in case that the length of the touch trajectory extracted by the mobile device 700 corresponds to the L2, since the L2 is matched with the security level of the first stage, the mobile device 700 can provide a user interface of a low security level. By doing so, as depicted in FIG. 7 (c), the mobile device 700 can skip a conversion to the display pages 70d set with a high security level and can display a user interface corresponding to the display page 70e in a screen 710.

Subsequently, in case that the length of the touch trajectory extracted by the mobile device 700 corresponds to the L3, since the L3 is matched with the security level of the third stage, the mobile device 700 can provide a user interface of a high security level. By doing so, as depicted in FIG. 7 (b), the mobile device 600 can display a user interface corresponding to the display page 70d set with a high security level in the screen 710.

As mentioned in the foregoing description, although an identical user uses the mobile device, the mobile device 700 can change a user interface provided according to the length of the touch trajectory. In particular, if the length (L3) of the touch trajectory is long, the mobile device 700 can switch the contents 70 provided in the screen 710 in a sequence of 70d and 70e. Yet, if the length (L2) of the touch trajectory is short, the mobile device 700 skips the display page 70d and can provide a user interface corresponding to the display page 70e in the screen 710.

In this case, the display page 70e is situated at the right (i.e., page shift direction) of the display page 70c in the sequence. Hence, the mobile device 700 can sequentially provide the display page 70b to 70d of a locked state in response to the second touch input of a user dragged to the right.

Yet, if a direction of the second touch input corresponds to the left, the mobile device can sequentially provide the display page 70b and the display page 70a, which are set as pages previous to the display page 70c in a sequence on the basis of the display page 70c. In this case, if a user interface corresponding to the security level of the first stage is available only due to a short touch trajectory, the mobile device skips the display page 70b and can immediately display the display page 70a.

As mentioned in the foregoing description, the mobile device according to one embodiment can provide a different user interface according to the direction of the second touch input. Regarding this, it is described with reference to FIG. 8. FIG. 8 is a diagram for one embodiment that a mobile device detects a direction and a length of a touch trajectory.

The mobile device according to one embodiment can detect a first touch input on the fingerprint verification area 810. The mobile device can detect a second touch input, which is concatenated to the first touch input, on the display area 820 within a preset time period from a point on which the first touch input is detected. In this case, the mobile device recognizes a touch trajectory made by the second touch input and can extract at least one of a length of the touch trajectory and a direction of the touch trajectory.

In this case, the mobile device according to one embodiment can provide a different type of user interface according to the direction of the touch trajectory. And, the type of the user interface can be determined by at least one of a security level, a type of content, and an order of content containing a sequence.

For instance, as mentioned earlier in FIG. 6 to FIG. 7, in case that the mobile device provides a user interface corresponding to the content including a plurality of display pages forming a sequence, the mobile device can display a different display page according to the direction of the touch trajectory.

As depicted in FIG. 8 (a), the mobile device can detect the second touch input on the display area 820, which is concatenated to the first touch input on the fingerprint verification area 810. In this case, the mobile device can recognize a touch trajectory made by the second touch input. By doing so, the mobile device can extract a length (L1) of the touch trajectory and a direction (810a) of the touch trajectory.

For instance, as depicted in FIG. 6 to FIG. 7, if content includes a plurality of display pages, the mobile device can identify a user interface having an accessible security level based on the length (L1) of the touch trajectory corresponding to the second touch input according to FIG. 8 (a).

And, the mobile device can determine a page to be shifted based on the direction (810a) of the touch trajectory. Hence, the mobile device can provide a user interface corresponding to a display page of a right side in sequence. And, in order to display a display page corresponding to a security level according to the length (L1) of the touch trajectory, the mobile device can skip a display page if necessary.

And, as depicted in FIG. 8 (b), the mobile device can detect the second touch input on the display area 820, which is concatenated to the first touch input on the fingerprint verification area 810. In this case, the mobile device can recognize a touch trajectory made by the second touch input and can extract a length (L2) of the touch trajectory and a direction (810b) of the touch trajectory.

For instance, as depicted in FIG. 6 to FIG. 7, if content includes a plurality of display pages, the mobile device can identify a user interface having an accessible security level based on the length (L2) of the touch trajectory corresponding to the second touch input according to FIG. 8 (b). In this case, since the L2 is shorter than the L1, a security level may become lower.

And, the mobile device can determine a page to be shifted based on the direction (810b) of the touch trajectory. Hence, the mobile device can provide a user interface corresponding to a display page of a left side in sequence. And, in order to display a display page corresponding to a security level according to the length (L2) of the touch trajectory, the mobile device can skip a display page if necessary.

As mentioned in the foregoing description, the mobile device according to one embodiment can provide a user interface corresponding to a preset type and a preset security level according to at least one of the direction of the touch trajectory and the length of the touch trajectory, which corresponds to the second touch input.

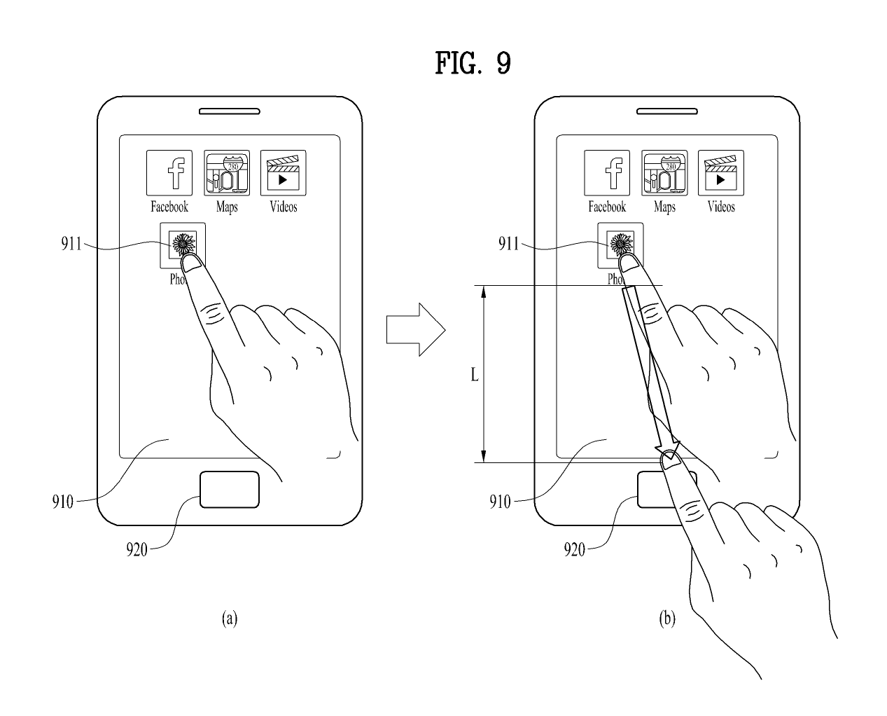

Meanwhile, a representative embodiment that the mobile device firstly detects the first touch input on the fingerprint verification area and continuously detects the second touch input on the display area is explained so far. Yet, unlike the above mentioned, the mobile device detects a first touch input on the display area, detects a second touch input on the fingerprint verification area, and can provide a user interface corresponding to a security level according to a touch trajectory made by the first touch input. Regarding this, it is explained in detail with reference to FIG. 9.

FIG. 9 is a diagram for one embodiment that a mobile device detects a length of a touch trajectory and a fingerprint.

As depicted in FIG. 9 (a), the mobile device can detect a first touch input on the display area 910. And, the mobile device can recognize a touch trajectory made by the first touch input. By doing so, the mobile device can extract at least one of a length (L) of the touch trajectory and a direction of the touch trajectory.

As depicted in FIG. 9 (b), the mobile device can detect a second touch input, which is concatenated to the first touch input, on the fingerprint verification area 920 within a preset time period from a point on which the first touch input is detected. And, the mobile device can extract fingerprint information using the second touch input on the fingerprint verification area 920. By doing so, if the fingerprint information is matched with pre-stored fingerprint information, the mobile device can provide a user interface corresponding to a security level preset according to the length (L) of the touch trajectory. In this case, the user interface is a user interface corresponding to an application selected by the first touch input of a user and the content provided to the user interface may vary according to a security level.

Meanwhile, as depicted in FIG. 9, in case that the mobile device detects a touch input on an icon corresponding to an application, the mobile device can immediately execute the application corresponding to the icon in general. Yet, the mobile device according to one embodiment can disable an operation followed by the first touch input. Because if the mobile device according to one embodiment detects the second touch input within a preset time period from a point on which the first touch input is detected, the mobile device can provide a user interface corresponding to the application in a manner of changing a security level of the user interface. Hence, if the mobile device detects the first touch input, the mobile device can disable the operation followed by the first touch input for the preset time period to detect the second touch input within the preset time period. Hence, if the mobile device does not detect the second touch input, the mobile device can perform the operation followed by the first touch input when the preset time period elapsed.

Meanwhile, the characteristics mentioned earlier in FIG. 3 to FIG. 8 can be identically applied to the mobile device detecting the first touch input on the display area and detecting the second touch input on the fingerprint verification area.

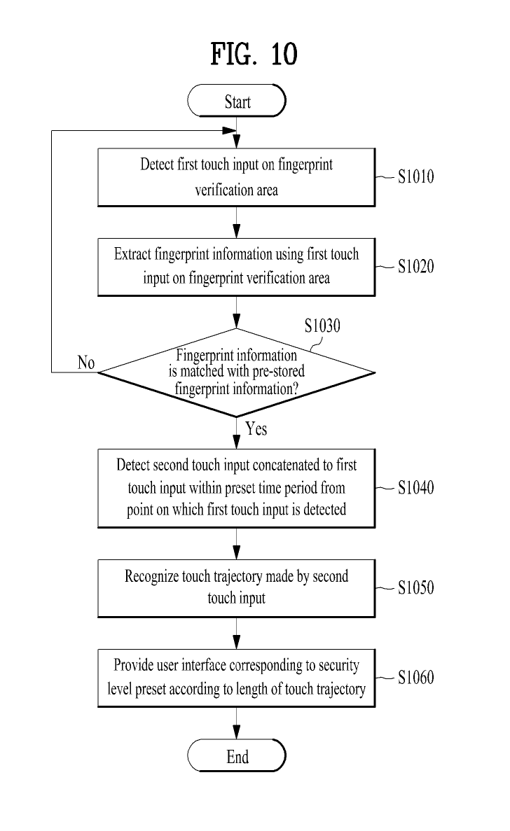

FIG. 10 is a flowchart for a method of controlling a mobile device according to one embodiment.

First of all, as mentioned earlier in FIG. 2, the mobile device can detect a first touch input on a fingerprint verification area [S1010]. And, the mobile device can extract fingerprint information using the first touch input on the fingerprint verification area [S1020]. The mobile device can judge whether the extracted fingerprint information is matched with pre-stored fingerprint information [S1030].

As mentioned earlier in FIG. 3, if the extracted fingerprint information is matched with the pre-stored fingerprint information, the mobile device can detect a second touch input concatenated to the first touch input within a preset time period from a point on which the first touch input is detected [S1040]. And, as mentioned earlier in FIG. 4 to FIG. 5, the mobile device can recognize a touch trajectory made by the second touch input [S1050].

And, as mentioned earlier in FIG. 4 to FIG. 7, the mobile device can provide a user interface corresponding to a security level preset according to a length of the touch trajectory [S1060]. For instance, as the length of the touch trajectory is longer, the mobile device can provide a preset user interface of a higher security level.

Yet, as mentioned earlier in FIG. 3, if the length of the touch trajectory is shorter than a preset reference, the mobile device can disable an operation followed by the second touch input.

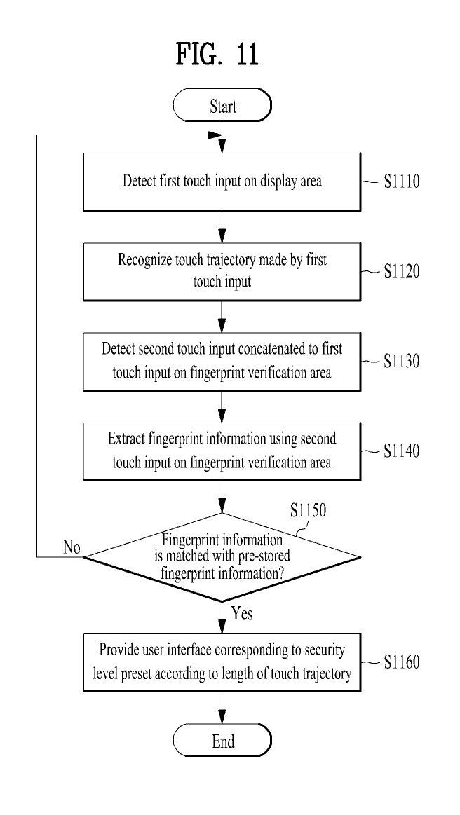

Meanwhile, FIG. 11 is a flowchart for a method of controlling a mobile device according to a different embodiment. Unlike FIG. 10, the mobile device can perform fingerprint verification after a touch on the display area.

First of all, as mentioned earlier in FIG. 9, the mobile device can detect a first touch input on a display area [S1110]. The mobile device can recognize a touch trajectory made by the first touch input [S1120].

And, the mobile device can detect a second touch input concatenated to the first touch input on a fingerprint verification area [S1130]. In this case, the second touch input may correspond to a sliding input. And, the mobile device can extract fingerprint information using the second touch input on the fingerprint verification area [S1140].

The mobile device can judge whether the extracted fingerprint information is matched with pre-stored fingerprint information [S1150]. As mentioned earlier in FIG. 4 to FIG. 7, the mobile device can provide a user interface corresponding to a security level preset according to a length of the touch trajectory [S1160].

For clarity of explanation, each diagram is explained in a manner of being divided. Yet, it is possible to design a new embodiment to implement the new embodiment by combining the embodiments, which are described in each of the diagrams. And, according to the necessity of those skilled in the art, designing a recording media readable by the computer, which has recorded a program for executing the previously explained embodiments, also belongs to a scope of a right.

A mobile device and a method of controlling therefor according to the present specification may not limitedly apply to the composition and method of the aforementioned embodiments. The aforementioned embodiments may be configured in a manner of being selectively combined the whole of the embodiments or a part of the embodiments to achieve various modifications.

Meanwhile, a method of controlling a mobile device can be implemented with a code readable by a processor in a recording media readable by the processor, which is equipped in a network device. The recording media readable by the processor may include all kinds of recording devices for storing data capable of being read by the processor. The examples of the recording media readable by the processor may include a ROM, a RAM, a magnetic tape, a floppy disc, an optical data storing device and the like.

And, to implement in a form of a carrier wave such as a transmission via the internet and the like is also included. And, since the recording media readable by the processor are distributed to the computers connected by a network, codes readable by the processor can be stored and executed in a manner of being distributed.

While the present specification has been described and illustrated herein with reference to the preferred embodiments and diagrams thereof, the present specification may be non-limited to the aforementioned embodiments and it will be apparent to those skilled in the art that various modifications and variations can be made therein without departing from the spirit and scope of the present specification. Thus, it is intended that the present specification covers the modifications and variations of this invention that come within the scope of the appended claims and their equivalents.

And, both an apparatus invention and a method invention are explained in the present specification and the explanation on the both of the inventions can be complementally applied, if necessary.

1. A mobile device, comprising:
a sensor;
a display unit with a display area; and
a hardware processor configured to control the sensor and the display unit,
wherein the hardware processor is further configured to:
detect a first touch input on a fingerprint verification area,
extract a fingerprint information using the first touch input on the fingerprint verification area using the sensor,
detect a second touch input after the first touch input within a preset time period from a point on which the first touch input is detected when the extracted fingerprint information is matched with a pre-stored fingerprint information, wherein the fingerprint information is extracted before the second touch input is detected,
recognize a touch trajectory made by the second touch input, and
provide a preset user interface of a security level that is determined based on the touch trajectory of the second touch input, wherein the security level is determined after determining whether to unlock the mobile device based on the fingerprint information of the first touch input.

2. The mobile device of claim 1, wherein the hardware processor is further configured to provide the preset user interface of a first security level when a length of the touch trajectory is longer than a preset reference.

3. The mobile device of claim 1, wherein the hardware processor is further configured to ignore the second touch input when a length of the touch trajectory is shorter than a preset reference.

4. The mobile device of claim 1, wherein the hardware processor is further configured to:
extract a direction of the touch trajectory made by the second touch input, and
provide a different type of user interface according to the direction of the touch trajectory.

5. The mobile device of claim 4, wherein the hardware processor is further configured to provide a user interface corresponding to a preset type and a preset security level according to the direction of the touch trajectory and a length of the touch trajectory.

6. The mobile device of claim 1, wherein the first touch input comprises a sliding input.

7. The mobile device of claim 1, wherein the second touch input comprises a drag input on a display area.

8. The mobile device of claim 1, wherein the second touch input comprises a touch input not after the first touch input within the preset time period from the point on which the first touch input is detected.

9. The mobile device of claim 1, wherein the hardware processor is further configured to:
unlock a locked state of the mobile device, and
set a touch screen to an enabled state.

10. The mobile device of claim 1, wherein the user interface comprises a user interface for at least one selected from the group consisting of a shortcut, a home screen, content, and an application.

11. A method of controlling a mobile device, comprising:
detecting a first touch input on a fingerprint verification area by the mobile device;
extracting a fingerprint information using the first touch input on the fingerprint verification area by the mobile device;
detecting a second touch input after the first touch input within a preset time period from a point on which the first touch input is detected by the mobile device when the extracted fingerprint information is matched with a pre-stored fingerprint information, wherein the fingerprint information is extracted before the second touch input is detected;
recognizing a touch trajectory made by the second touch input by the mobile device; and
providing a preset user interface of a security level that is determined based on the touch trajectory of the second touch input, wherein the security level is determined after determining whether to unlock the mobile device based on the fingerprint information of the first touch input.

12. The method of claim 11, wherein the step of providing the preset user interface provides the preset user interface of a first security level as a length of the touch trajectory is longer than a preset reference.

13. The method of claim 11, further comprising disabling an operation followed by the second touch input when a length of the touch trajectory is shorter than a preset reference.

14. The method of claim 11, further comprising:
extracting a direction of the touch trajectory made by the second touch input; and
providing a different type of user interface according to the direction of the touch trajectory.

15. The method of claim 14, further comprising providing a user interface corresponding to a preset type and a preset security level according to the direction of the touch trajectory and a length of the touch trajectory.

16. The method of claim 11, wherein the first touch input comprises a sliding input.

17. The method of claim 11, wherein the second touch input comprises a drag input on a display area.

18. The method of claim 11, further comprising unlocking a locked state of the mobile device when the extracted fingerprint information is matched with the pre-stored fingerprint information.

19. The method of claim 11, wherein the user interface comprises a user interface for at least one selected from the group consisting of a shortcut, a home screen, content, and an application.

20-22. (canceled)
